(19) United States
(12) Patent Application Publication
(10) Pub. No.: US 2005/0283831 A1
(43) Pub. Date: Dec. 22, 2005

(54) Security system and method using server security solution and network security solution

(75) Inventors: Yeon-Sik Ryu, Gyeonggi-Do (KR); Hae-Jin Lee, Seoul (KR)

Correspondence Address: BIRCH STEWART KOLASCH & BIRCH, PO BOX 747, FALLS CHURCH, VA, 22040-0747, US

(73) Assignee: LG N-Sys Inc., Seoul (KR)

(21) Appl. No.: 10/962,440

(22) Filed: Oct. 13, 2004

(30) Foreign Application Priority Data
Jun. 21, 2004 (KR) 2004-45984

(51) Int. Cl. G06F 15/16; G06F 17/00; G06F 9/00

(52) U.S. Cl. 726/11

(57) ABSTRACT

A security method and system using a server security solution and a network security solution is disclosed. In the security method based on the security system that has a firewall for blocking malicious access to a corresponding network, a network intrusion prevention system for blocking intrusion into the network and server systems including a mail server and a File Transfer Protocol (FTP) server, the server systems transmit information on an intruding system, which has transmitted harmful traffic, to the network intrusion prevention system at the time of detecting the harmful traffic. The network intrusion prevention system blocks the access of the harmful traffic based on the information transmitted from the server systems. According to the present invention, the server systems detect malicious intrusion attempts, and intrusion is blocked at a network level, so that the present invention is effective in that second and third malicious intrusion attempts can be fundamentally blocked and the consumption of network resources attributable to repeated intrusion attempts can be prevented.

### BACKGROUND OF THE INVENTION

1. Field of the Invention

The present invention relates generally to a security method and system using a server security solution and a network security solution and, more particularly, to a security method and system, in which a server security solution and a network security solution interwork with each other, thus blocking the access of a harmful system using the network security solution based on information detected by the server security solution.

2. Description of the Related Art

Recently, as information technology has become popularized with the assistance of the rapid development of information and communication technology combined with computers, network environments and the Internet have become popularized. With the development of information technology based on such network environments, a plurality of client terminals can exchange or search for required information while connecting to a main server on-line.

However, malicious network access, such as intrusion into server systems and the transmission of harmful traffic, frequently occurs using available online access via a corresponding network.

Conventional security solutions have been provided to block such malicious network access. Conventional security systems are classified into two types of technologies, and the two types of technologies are described below. FIG. 1 is a diagram showing the construction of a conventional server network security system.

The conventional security system employing the first technology is constructed in such a way as to block content-based harmful attacks and Denial of Service (DoS) attacks through interworking between a firewall 300 for blocking the access of harmful traffic based on information on the Internet Protocol (IP) address of an accessing system 100 and information on the service port numbers of server systems, such as a mail server 200 and a File Transfer Protocol (FTP) server 201, and a network intrusion detection system 400 for detecting network-based intrusion and informing an administrator of the intrusion using the copies of packets generated through a proper method such as mirroring or tapping. A method of interworking between the firewall 300 and the network intrusion detection system 400 is performed in such a way that the network intrusion detection system 400 directly transmits the IP address of the accessing system 100 to be blocked or the service port numbers of server systems 200 and 201 through an Application Protocol Interface (API) provided by the firewall 300.

When the network intrusion detection system 400 detects an attack the network intrusion detection system 400 transmits the IP address of the accessing system 100 to be blocked or the service port numbers of the server systems 200 and 201 to the firewall 300. Using the information received as described above, the firewall 300 blocks the IP address to prevent access from the IP address of the accessing system 100, or receives the service port numbers of the server systems 200 and 201 and prevents the access of the accessing system 100 to a specific service port of the server systems 200 and 201.

The conventional security system employing the second technology is constructed in such a way that the server systems 200 and 201 directly operate a server security solution and malicious access to servers is detected and refused, thus preventing the accessing system 100 from using the resources of the servers.

In FIG. 1, reference numerals 120 and 140 indicate the Internet and a router, respectively.

The first technology has a limitation in that malicious intrusion attempts for the illegal use of a server (e.g., repeated attempts at illegal login, attempts at access to access-limited resources within a server, etc.) or encrypted intrusion attempts cannot be detected, so that the first technology is problematic in that network and server resources cannot be completely protected from the malicious intrusion attempts.

The second technology can protect the server systems 200 and 201 by refusing the malicious attempts at access to the servers that cannot be solved using the first technology in which the firewall 300 and the network intrusion detection system 400 interwork with each other. However, the second technology is problematic in that traffic harmful to the network resources is continuously generated as the malicious attempts at intrusion into a corresponding server are repeated, thus causing delay in normal network communication operations. Furthermore, the second technology is problematic in that second and third malicious attempts at intrusion into other servers are repeated, thus affecting the provision of the services of the servers.

### SUMMARY OF THE INVENTION

Accordingly, the present invention has been made keeping in mind the above problems occurring in the prior art and an object of the present invention is to provide a security method and system in which the access of a harmful system is blocked by a network security solution based on information detected by a server security solution.

In order to accomplish the above object, the present invention provides a security method using server and network security solutions based on a system, the system having a firewall for blocking malicious access to a corresponding network, a network intrusion prevention system for blocking intrusion into the network and server systems including a mail server and an FTP server, the security method including the first step of transmitting information on an intruding system, which has transmitted harmful traffic, to the network intrusion prevention system when the server systems detect the harmful traffic, and the second step of the network intrusion prevention system blocking the access of the harmful traffic based on the information transmitted from the server systems.

At the first step, the server systems may transmit information on countermeasures against the intrusion into the network, along with information on the intruding system, to the network intrusion prevention system and an intrusion prevention management system; after the first step, the intrusion prevention management system may update an existing security policy by adding the information, transmitted from the server systems, to the existing security policy, and transmitting the updated security policy to the server systems and the network intrusion prevention system; at the second step, the network intrusion prevention system may detect and block the harmful traffic based on the information transmitted from the server systems or the updated security policy, and transmits information related to the detection and blocking of the harmful traffic to the intrusion prevention management system; and after the second step, the intrusion prevention management system may update the updated security policy again by adding the information, transmitted from the network intrusion prevention system, to the updated security policy.

The server systems may be each equipped with a server security agent that is software for server security, and the server security agent may function to detect the harmful traffic and transmit information on the harmful traffic to the network intrusion prevention system and the intrusion prevention management system.

The information on the intruding system may be information on the IP address of the intruding system and an access port, and the information on countermeasures against the intrusion may be information on a traffic blocking type and a traffic blocking time.

In order to accomplish the above object, the present invention provides a security system, including server systems for detecting harmful traffic related to a malicious attempt at intrusion into a server and transmitting information on an intruding system that has transmitted the harmful traffic, and a network intrusion prevention system for blocking the access of the harmful traffic based on the information transmitted from the server systems.

The security system may further include an intrusion prevention management system for setting, modifying and managing a security policy required to operate the server systems and the network intrusion prevention system.

The server systems may be each equipped with a server security agent that is software for detecting the harmful traffic and transmitting information on the harmful traffic to the intrusion prevention system.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a conventional server network security system;

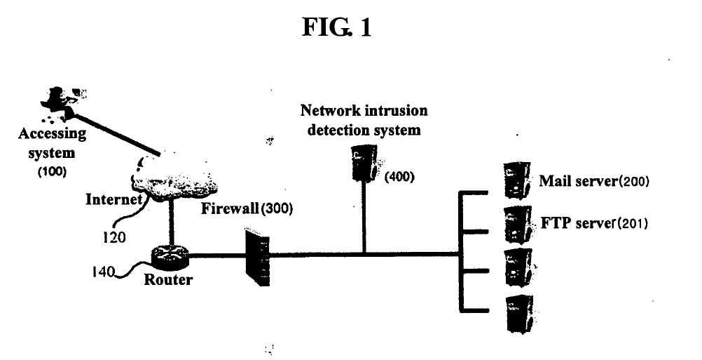

FIG. 2 is a diagram showing the construction of a server network security system according to an embodiment of the present invention; and

FIG. 3 is a flowchart showing a system security method using a server security solution and a network security solution.

### DESCRIPTION OF THE PREFERRED EMBODIMENTS

Embodiments of the present invention are described in detail with reference to the attached drawings below. In the drawings, the same reference numerals are used throughout the different drawings to designate the same components. Additionally, detailed descriptions of well-known functions and constructions, which may make the gist of the present invention unclear, are omitted.

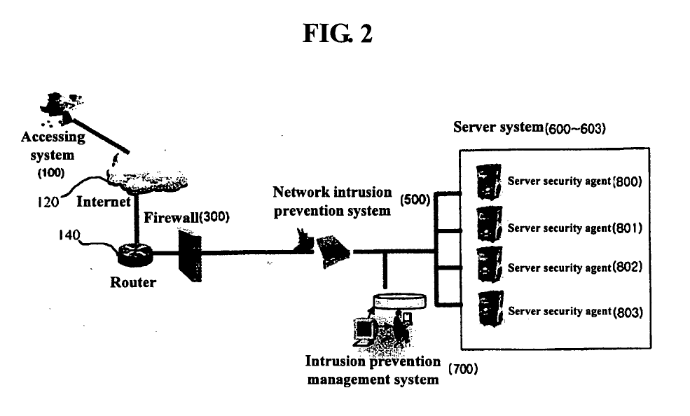

FIG. 2 is a diagram showing the construction of a server network security system according to an embodiment of the present invention. The security system includes a firewall 300 for blocking malicious access to a corresponding network, a network intrusion prevention system 500, server systems 600 to 603, an intrusion prevention management system 700, and server security agents 800 to 803.

The network intrusion prevention system 500 functions to block intrusion into a network, detect harmful traffic by inspecting the information of packets that constitute network traffic, and block the access of the harmful traffic based on information transmitted from the server systems 600 to 603. Furthermore, the network intrusion prevention system 500 functions to control the amount of traffic using network-related information, such as a protocol, an IP address, a port address and an application.

The server systems 600 to 603 are each equipped with the server security agent 800, 801, 802 or 803 to prevent malicious attempts at intrusion into a server. The server security agents 800 to 803 function to detect harmful traffic and transmit information on the detected harmful traffic to the network intrusion prevention system 500. In this case, the information includes information on the IP address of an intruding system, an access port, a traffic blocking type and a traffic blocking time.

The server security agents 800 to 803 store events according to a security policy set by monitoring various events of the server systems using various methods.

The intrusion prevention management system 700 functions to set, modify and manage the security policy required to operate the server systems 600 to 603 and the network intrusion prevention system 500.

The malicious attempts at intrusion into the server systems 600 to 603 may occur in various forms. The first is the case where an accessing system 100 repeatedly attempts to log in so as to obtain the administrator authority of a target server system 600, 601, 602 or 603. In this case, the server security agents 800 to 803 detect such an attempt, and transmit information on the user of the accessing system 100 to the network intrusion prevention system 500 using a network communication. The network intrusion prevention system 500 blocks the connection or attempt of the accessing system 100 using information received from the server systems 600 to 603.

The second is the case where the accessing system 100 accesses the important resources (files or registries) or prohibited resources of the server systems 600 to 603 using Telnet or FTP. In this case, the server security agents 800 to 803 detect such access, and transmit information on the user of the accessing system 100 to the intrusion prevention system 500 through a network communication. The network intrusion prevention system 500 blocks the connection of the accessing system 100 based on the received information.

The third is the case where the accessing system 100 accesses the server systems 600 to 603 while bypassing the network intrusion prevention system 500. A fragmentation or encryption method is used as the method of bypassing the network intrusion prevention system 500, and the network intrusion prevention system 500 cannot detect access that uses a fragmentation or encryption method. In this case, since the server security agents 800 to 803 installed in the server systems 600 to 603 are based on hosts, the server security agents 800 to 803 detect such access, transmit information on the accessing system 100 to the network intrusion prevention system 500, and block an attack attempt.

In FIG. 2, reference numerals 120 and 140 indicate the Internet and a router, respectively.

A security method using a server and a network in the security system is described in detail below.

The security method is divided into two steps. The first step is performed in such a way that the server systems 600 to 603 transmit information on an intruding system, which has transmitted harmful traffic, to the network intrusion prevention system 500 at the time of detecting the harmful traffic, and the second step is performed in such a way that the network intrusion prevention system 500 blocks the access of the harmful traffic based on the information transmitted from the server systems 600 to 603.

The two steps are described in more detail below.

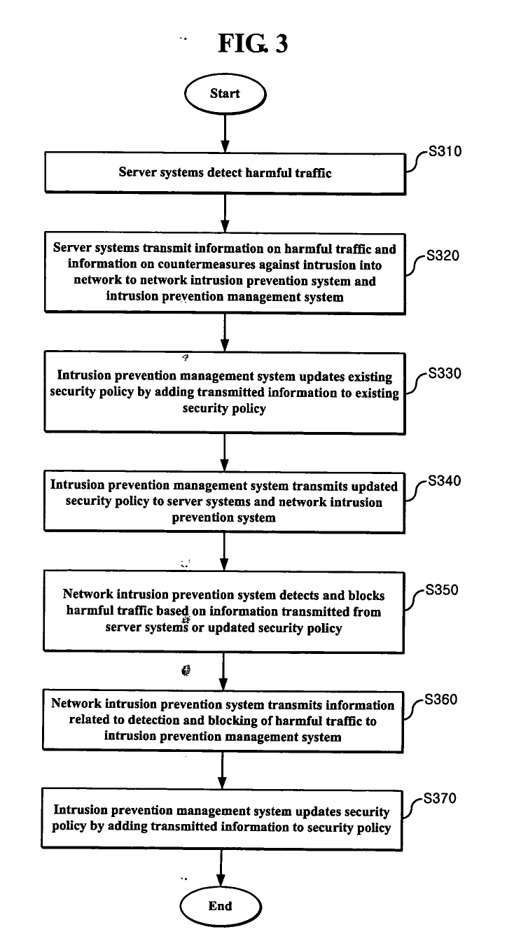

FIG. 3 is a flowchart showing a system security method using a server security solution and a network security solution according to an embodiment of the present invention.

The server systems 600 to 603 detect harmful traffic at step S310. The server systems 600 to 603 transmit information on countermeasures against intrusion into a network, along with information on an intruding system and the harmful traffic, to the network intrusion prevention system 500 and the intrusion prevention management system 700 at step S320. In this case, the server systems 600 to 603 are each equipped with the server security agent 800, 801, 802 or 803 that is software for server security, and the server security agent 800, 801, 802 or 803 functions to detect the harmful traffic and transmit information on the harmful traffic to the network intrusion prevention system 500 and the intrusion prevention management system 700. The information on the intruding system is information on the IP address of the intruding system and an access port, while the information on countermeasures against the intrusion may be information on a traffic blocking type and a traffic blocking time.

Thereafter, the intrusion prevention management system 700 updates an existing security policy by adding the information, transmitted from the server systems 600 to 603, to the existing security policy at step S330. Furthermore, the intrusion prevention management system 700 transmits the updated security policy to the server systems 600 to 603 and the network intrusion prevention system 500 at step S340.

The network intrusion prevention system 500 detects and blocks the harmful traffic based on the information transmitted from the server systems 600 to 603 or the updated security policy at step S350. Furthermore, the network intrusion prevention system 500 transmits information related to the detection and blocking of the harmful traffic to the intrusion prevention management system 700 at step S360.

The intrusion prevention management system 700 updates the updated security policy again by adding the information, transmitted from the network intrusion prevention system 500, to the updated security policy at step S370.

As described above, according to the present invention, the server systems detect malicious intrusion attempts, and intrusion is blocked at a network level, so that the present invention is effective in that second and third malicious intrusion attempts can be fundamentally blocked and the consumption of network resources attributable to repeated intrusion attempts can be prevented. Furthermore, malicious attempts at intrusion into other servers are blocked, so that the present invention is effective in that the server systems do not respond to the malicious intrusion attempts, thus improving the use of resources.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A security method using server and network security solutions based on a system, the system having a firewall for blocking malicious access to a corresponding network, a network intrusion prevention system for blocking intrusion into the network, and server systems including a mail server and a File Transfer Protocol (FTP) server, the security method comprising:
the first step of transmitting information on an intruding system, which has transmitted harmful traffic, to the network intrusion prevention system when the server systems detect the harmful traffic; and
the second step of the network intrusion prevention system blocking access of the harmful traffic based on the information transmitted from the server systems.

2. The security method as set forth in claim 1, wherein:
at the first step, the server systems transmit information on countermeasures against the intrusion into the network, along with information on the intruding system, to the network intrusion prevention system and an intrusion prevention management system;
after the first step, the intrusion prevention management system updates an existing security policy by adding the information, transmitted from the server systems, to the existing security policy, and transmitting the updated security policy to the server systems and the network intrusion prevention system;
at the second step, the network intrusion prevention system detects and blocks the harmful traffic based on the information transmitted from the server systems or the updated security policy, and transmits information related to the detection and blocking of the harmful traffic to the intrusion prevention management system; and
after the second step, the intrusion prevention management system updates the updated security policy again by adding the information, transmitted from the network intrusion prevention system, to the updated security policy.

3. The security method as set forth in claim 2, wherein the server systems are each equipped with a server security agent that is software for server security, and the server security agent functions to detect the harmful traffic and transmit information on the harmful traffic to the network intrusion prevention system and the intrusion prevention management system.

4. The security method as set forth in claim 2, wherein the information on the intruding system is information on an Internet Protocol (IP) address of the intruding system and an access port, and the information on countermeasures against the intrusion is information on a traffic blocking type and a traffic blocking time.

5. A security system, comprising:
server systems for detecting harmful traffic related to a malicious attempt at intrusion into a server and transmitting information on an intruding system that has transmitted the harmful traffic; and
a network intrusion prevention system for blocking access of the harmful traffic based on the information transmitted from the server systems.

6. The security system as set forth in claim 5, further comprising an intrusion prevention management system for setting, modifying and managing a security policy required to operate the server systems and the network intrusion prevention system.

7. The security system as set forth in claim 5, wherein the server systems are each equipped with a server security agent that is software for detecting the harmful traffic and transmitting information on the harmful traffic to the intrusion prevention system.
